(19) United States
(12) Patent Application Publication
(10) Pub. No.: US 2005/0185269 A1
(43) Pub. Date: Aug. 25, 2005

(54) Catadioptric projection objective with geometric beam splitting

(75) Inventors: Alexander Epple, Aalen (DE); Helmut Beierl, Heidenheim (DE); Aurelian Dodoc, Oberkochen (DE); Wilhelm Ulrich, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/014,857

(22) Filed: Dec. 20, 2004

Related U.S. Application Data
(60) Provisional application No. 60/530,622, filed on Dec. 19, 2003.

(51) Int. Cl. G02B 1/00; G02B 17/00; G02B 21/00; G02B 23/00

(52) U.S. Cl. 359/366; 359/362

(57) ABSTRACT

A catadioptric projection objective for imaging a pattern arranged on the object plane of the projection objective, on the image plane of the projection objective, comprising: a first objective part for imaging an object field in a first real intermediate image; a second objective part for producing a second real intermediate image with the radiation coming from the first objective part; and a third objective part for imaging the second real intermediate image on the image plane; wherein at least one of the objective parts is a catadioptric objective part with a concave mirror, and at least one of the objective parts is a refractive objective part and a folding mirror is arranged within this refractive objective part in such a way that a field lens is arranged between the folding mirror and an intermediate image which is closest to the folding mirror.

### BACKGROUND TO THE INVENTION

1. Field of the Invention

The invention relates to a catadioptric projection objective for imaging a pattern arranged on the object plane of the projection objective, on the image plane of the projection objective.

2. Description of the Related Prior Art

Projection objectives such as these are used in microlithography projection exposure systems for producing semiconductor components and other finely structured components. They are used to project patterns of photomasks or reticles, which are referred to in a generalized form in the following text as masks or reticles, onto an object which is coated with a light-sensitive layer, with very high resolution and on a reduced scale.

In this case, in order to produce ever finer structures, the numerical aperture (NA) of the projection objective on the image side must on the one hand be increased and, on the other hand, ever-shorter wavelengths must be used, preferably ultraviolet light at wavelengths of less than about 260 nm, for example 248 nm, 193 nm or 157 nm.

In the past, purely refractive projection objectives have predominantly been used for optical lithography. These are distinguished by a mechanically relatively simple, centered design, which has only a single, unfolded optical axis. Furthermore, it is possible to use object fields which are centered on the optical axis, which minimize the light guidance value to be corrected, and simplify the adjustment of the objective.

However, the form of the refractive design is governed by two elementary imaging errors: the chromatic correction and correction for the Petzval sum (image field curvature).

In the case of catadioptric designs which have at least one catadioptric objective part and a hollow mirror or concave mirror the Petzval condition is corrected more easily, and chromatic correction is possible. In this case, the Petzval correction is achieved by the curvature of the hollow mirror and negative lenses in its vicinity, while chromatic correction is achieved by the refractive power of the negative lenses in front of the hollow mirror (for CHL) as well as the diaphragm position with respect to the hollow mirror (CHV).

One disadvantage of the catadioptric design is, however, that it is necessary to work either with off-axis object fields, that is to say with an increased light guidance value (in systems with geometric beam splitting), or with physical beam splitter elements, which generally cause polarization problems.

In the case of off-axis catadioptric systems, that is to say in the case of systems with geometric beam splitting, the requirements for the optical design can be formulated as follows: (1) reduce the light guidance value as far as possible, (2) design the geometry of the folds (beam deflections) such that a mounting technique can be developed for this purpose, and (3) provide effective correction, in which case, in particular, the Petzval sum and the chromatic aberrations can be corrected jointly in the catadioptric mirror group.

In order to keep the geometric light guidance value (Etendue) low, the design should in principle be folded in the area of low NA (that is to say, for example, close to the object) and in the vicinity of orifices (that is to say close to the reticle or close to a real intermediate image).

However, as the numerical aperture is increased, the object-side numerical aperture also increases, and hence the distance between the first folding mirror and the reticle, so that the light guidance value rises. Furthermore, the diameter of the hollow mirror increases, as does the size of the folding mirror. This can result in physical space problems.

This can be overcome by first of all imaging the reticle by means of a first refractive relay system on an intermediate image, and by making the first fold in the area of the intermediate image. A catadioptric system such as this is disclosed in EP 1 191 378 A1. This has a catadioptric objective part with a concave mirror. The light falls from the object plane on a folding mirror (deflection mirror) which is located in the vicinity of the first intermediate image, from there to the concave mirror and from there (producing a second real intermediate image in the vicinity of a second deflection mirror) into a refractive objective part, which images the second intermediate image on the image plane (wafer).

Systems with a similar design are disclosed in WO 03/036361 A1 or U.S. No. 2002/0197946 A1.

Other catadioptric systems with two real intermediate images are disclosed in JP 2002-372668 and the Patent U.S. Pat. No. 5,636,066. WO 02/082159 A1 discloses a different catadioptric system with a plurality of intermediate images.

### SUMMARY OF THE INVENTION

The invention is based on the object of providing a catadioptric projection objective which allows imaging errors to be corrected well, while having an advantageous physical form and an advantageous light guidance value. In particular, it should be possible to correct the Petzval sum and the chromatic aberrations in conditions which are advantageous for manufacture.

This object is achieved by a catadioptric projection objective which, according to one formulation of the invention, has a first objective part for imaging an object field in a first real intermediate image, a second objective part for producing a second real intermediate image with the radiation coming from the first objective part, and a third objective part for imaging the second real intermediate image on the image plane, with at least one of the objective parts being a catadioptric objective part with a concave mirror, and at least one of the objective parts being a refractive objective part and a folding mirror being arranged within this refractive objective part in such a way that a field lens is arranged between the folding mirror and an intermediate image which is closest to the folding mirror.

In this case, the expression “field lens” refers to an individual lens or a lens group having at least two individual lenses. The expression takes account of the fact that the function of a lens can in principle also be carried out by two or more lenses (splitting of lenses). The refractive power of this field lens is arranged close to the field, that is to say in the optical vicinity of a field plane. This area close to the field, with respect to a field plane, is characterized in particular in that the principal beam height of the image is large in comparison to the marginal beam height here. In this case, the marginal beam height is the beam height of a marginal beam which leads from the center of the object field to the margin of an aperture diaphragm, while the primary beam runs from a margin point of the object field parallel or at an acute angle to the optical axis, and intersects the optical axis in the area of the system diaphragm, that is to say at a diaphragm location which is suitable for the fitting of an aperture diaphragm.

The expression “intermediate image” refers to the area between a paraxial intermediate image and a marginal beam intermediate image. Depending on the correction state of the intermediate image, this area may extend over a certain axial area in which case, for example, the paraxial intermediate image may be located in the light path in front of or behind the marginal beam intermediate image, depending on the spherical aberration (undercorrection or overcorrection). The paraxial intermediate image and the marginal beam intermediate image may also essentially coincide. For the purposes of this application, an optical element, for example a folding mirror, is located “between” an intermediate image and an adjacent optical element, for example a lens when at least a part of the (generally axially extended) intermediate image is located between mutually adjacent optical surfaces of the adjacent optical element. The intermediate image may thus also partially extend over an optical surface, and this may, for example, be advantageous for correction purposes. The intermediate image is frequently located completely outside optical elements. Since the radiation energy density is particularly high in the intermediate image area, this may be advantageous, for example with respect to the radiation load on the optical elements.

Projection objectives according to the invention have at least one refractive objective part in which the optical axis is folded at least once between its object plane and its image plane. This creates new design degrees of freedom. These are evident in particular in conjunction with a catadioptric objective part which may be arranged in the radiation path before this refractive objective part or after this refractive objective part. A catadioptric objective part has a concave mirror (hollow mirror) with an associated folding mirror, in order to deflect either the radiation coming from the object plane in the direction of the concave mirror or the radiation reflected from the concave mirror in the direction of the image plane of the projection objective. This folding mirror may be located within a refractive objective part located closest to the catadioptric objective part, with an intermediate image existing in the light path between the concave mirror and this folding mirror. The field lens may be located between this intermediate image and the folding mirror. This makes it possible on the one hand for the intermediate image to be located relatively close to the folding mirror, which allows the optical guidance value of the system to be kept small. On the other hand, the field lens can be moved very close to the intermediate image without being adversely affected by the folding mirror, so that it is possible to effectively correct imaging errors. Since the objective parts may be designed such that the intermediate image which is close to the field lens is subject to severe aberration, imaging errors can be corrected particularly effectively. This will also be explained in detail in conjunction with the exemplary embodiments.

Although it is possible for the field lens to have negative refractive power, a field lens with positive refractive power is provided for the preferred embodiments. Positive refractive power in the divergent beam path between an upstream field plane and a downstream folding mirror can contribute to reducing the angle bandwidth of the incidence angle of the radiation striking the folding mirror, so that simpler layer designs are possible. Furthermore, the positive refractive power contributes to the lenses which are downstream in the beam path being able to have a relatively small diameter, thus making it possible to save lens material.

In one embodiment, the concave mirror has an associated folding mirror for deflecting the radiation coming from the object plane in the direction of the concave mirror, or for deflecting the radiation coming from the concave mirror in the direction of the image plane, and the field lens is arranged geometrically between the concave mirror and the folding mirror in an area through which the beam passes twice, such that a first lens area of the field lens is arranged in the beam path between the object plane and the concave mirror, and a second lens area of the field lens is arranged in the beam path between the concave mirror and the image plane.

The field lens can be arranged such that it is arranged not only in the optical vicinity of a field plane which is located in the beam path upstream of the concave mirror, but also in the optical vicinity of a field plane which is located in the beam path downstream from the concave mirror. This results in an arrangement close to the field with respect to two successive field planes, so that a major correction effect can be achieved at two points in the beam path.

At least one multiple area lens can be arranged in an area of the projection objective through which the beam passes twice, which multiple area lens has a first lens area through which the beam passes in a first direction and has a second lens area through which the beam passes in a second direction, with the first lens area and the second lens area not overlapping one another, at least on one side of the lens. This multiple area lens may be used as a field lens. If the “footprints” of the beam paths do not overlap on at least one of the two lens faces, a multiple area lens such as this makes it possible to move two lenses which act independently of one another geometrically to a common point. It is also possible to physically manufacture two lenses which act independently of one another as one lens, specifically an integral multiple area lens, from one lens blank. A multiple area lens such as this can clearly be distinguished from a conventional lens that is passed through twice since, in the case of a multiple area lens of this type, its optical effect on the beams passing through it independently of one another can be influenced by suitable independent forming of the refractive surfaces of the lens areas independently of one another. Alternatively, a lens arrangement having one or two half lenses or lens elements can also be arranged at the location of an integral multiple area lens, in order to influence the beams passing one another, independently of one another.

Projection objectives with geometric beam splitting, with an intermediate image and with a multiple area lens are known from WO 03/052462 A1 from the same applicant. The disclosure of this patent application is included by reference in the content of this description.

It is also possible for the field lens to be arranged in an area through which the radiation passes only once, for example between an object plane of a refractive objective part and a folding mirror arranged within the refractive objective part, or between a folding mirror arranged within a refractive objective part and the image plane of the refractive objective part. The “object plane” and the “image plane” of the refractive objective part may respectively be the object plane or image plane of the entire projection objective, or may be an intermediate image plane of the projection objective.

Projective objectives with geometric beam splitting, with a single intermediate image and with a positive lens between a folding mirror and the intermediate image arranged in its optical vicinity are disclosed in U.S. No. 2003/0021040 A1 from the same applicant. The disclosure in this patent application is included by reference in the content of this description.

In principle, a folded mirror may be provided in each of the objective parts (refractively or catadioptrically) in areas with a sufficiently long drift path, that is to say in areas with a sufficiently large axial distance between successive optical components. This may be used, for example, to create objective sections with an optical axis which is aligned vertically during operation. Lenses and other optical components in these vertical sections are influenced symmetrically by the force of gravity, so that aberrations caused by the force of gravity can be reduced or avoided. It is also possible for there to be two or more folding mirrors within one objective part.

A catadioptric projection objective according to the invention has at least two real intermediate images. In some systems, the second intermediate image is imaged directly on the image plane, that is to say without any further intermediate images being produced. This results in embodiments with two, and only two, real intermediate images.

In other embodiments, the third objective part has at least two imaging subsystems and at least one real intermediate image located between them. In particular, a projection objective such as this may have a first objective part for imaging an object field which is located on the object plane in a first real intermediate image, a second objective part for producing a second real intermediate image with the radiation coming from the first objective part, a third objective part for producing a third real intermediate image with the radiation coming from the second objective part, and a fourth objective part for imaging the third real intermediate image on the image plane, wherein at least one of the objective parts is a catadioptric objective part with a concave mirror, and at least one of the objective parts is a refractive objective part and a folding mirror is arranged within this refractive objective part in such a way that a field lens is arranged between the folding mirror and an intermediate image which is closest to the folding mirror.

A catadioptric projection objective such as this has at least three real intermediate images. In some systems, a third intermediate image is imaged directly on the image plane, that is to say without producing any further intermediate images. This results in embodiments with three, and only three, real intermediate images.

The first objective part may be used as a relay system, in order to use the radiation coming from the object plane to produce a first intermediate image with a correction state which can be predetermined at a suitable position. The first objective part is generally designed to be purely refractive. In some embodiments, at least one folding mirror is provided in this first objective part, which images the object plane in a first intermediate image, so that the optical axis is folded at least once, and preferably just once, within the objective part which is closest to the object.

The last objective part before the image plane is preferably purely refractive and can be optimized for producing high image-side and numerical apertures (NA). At least one folding mirror is preferably provided in this last objective part, which images a last intermediate image on the image plane, so that the optical axis is folded at least once, and preferably just once, within the objective part closest to the image.

In some embodiments, at least two of the objective parts are catadioptric, and each have a concave mirror. In particular, two, and only two, catadioptric objective parts may be provided.

In one development, the second objective part and the third objective part are designed as catadioptric systems each having one concave mirror. Each of the concave mirrors has an associated folding mirror in order to deflect either the radiation to the concave mirror or the radiation coming from the concave mirror in the direction of a downstream objective part.

The provision of at least two catadioptric subsystems has major advantages. In order to identify significant disadvantages of systems with only one catadioptric subsystem, it is necessary to consider how the Petzval sum and the chromatic aberrations are corrected in a catadioptric part. The contribution of a lens for chromatic longitudinal aberration CHL is given by
CHL∝h²·φ/ν
that is to say it is proportional to the marginal beam height h (squared), the refractive power φ of the lens and the dispersion ν of the material. On the other hand, the contribution of a surface to the Petzval sum depends only on the surface curvature and on the sudden change in the refractive index (which is −2 for a mirror).

In order to allow the contribution of the catadioptric group to the chromatic correction to become large, large marginal beam heights (that is to say large diameters) are thus required, and in order to allow the contribution to the Petzval correction to become large, large curvatures are required (that is to say small radii, which are best achieved by means of small diameters). These two requirements are contradictory.

The contradictory requirements for Petzval correction (that is to say for correction of the image field curvature) and chromatic correction can be solved by introducing (at least) one further catadioptric part into the system.

The two catadioptric systems can now be designed such that one has a tendency to have large diameters with flat radii for CHL correction, while the other has a tendency to have small diameters with sharp radii for Petzval correction.

In general, there is freedom to distribute the correction of these and other imaging errors uniformly or nonuniformly between two (or more) catadioptric subsystems. This makes it possible to provide very large apertures with an excellent correction state with a more lightly loaded design.

Catadioptric projection objectives having at least three real intermediate images and two catadioptric objective parts are disclosed, by way of example, in the U.S. provisional application with the Ser. No. 60/511,673, whose date of filing was Oct. 17, 2003, from the same applicant. The disclosure content of this patent application is included by reference in the content of this description.

There are also embodiments with only one catadioptric objective part. Preferred embodiments have a first refractive objective part for imaging the object field in a first real intermediate image, a catadioptric objective part for producing a second real intermediate image with the radiation coming from the first objective part, and a third, refractive objective part for imaging the second real intermediate image on the image plane. The catadioptric objective part is thus arranged between two refractive objective parts. A folding mirror is arranged within at least one of the refractive objective parts such that a field lens is arranged between the folding mirror and an intermediate image located closest to the folding mirror.

Systems according to the invention can preferably be used in the deep UV band, for example at 248 nm, 193 nm, 157 nm or below.

The invention makes it possible to design projection objectives whose image-side numerical aperture when using suitable immersion media is NA≧1.0, with even NA>1.1, in particular NA=1.2; NA=1.3 or more, being possible in some embodiments. The projection objectives may be matched to an immersion fluid which has a refractive index n_{I}>1.3 at the operating wavelength. This makes it possible to reduce the effective operating wavelength by about 30% or more in comparison to systems without immersion.

The structural features of preferred embodiments allow the projection objective to be used as an immersion objective. Projection objectives according to the invention are, however, not restricted to this use. The optical design also allows use for non-contacting near-field projection lithography. In this case, adequate light energy can be coupled into the substrate to be exposed, via a gap which is filled with gas, provided that a sufficiently short image-side working separation is maintained, averaged over time. This should be below four times the operating wavelength used, and in particular should be below the operating wavelength. It is particularly advantageous for the working separation to be less than half the operating wavelength, for example less than one third, one quarter or one fifth of the operating wavelength. These short working distances allow an image to be produced in the optical near field, in the case of which evanescent fields (which exist in the immediate vicinity of the last optical surface of the imaging system) are used for imaging.

If one wishes to use a projection objective for non-contacting near-field lithography instead of for immersion lithography, then this can easily be achieved by minor modifications. If the immersion medium to which the optical design is matched essentially has the same reflective index as the last optical element of the objective, then the solid body is made thicker in order to achieve a shorter image-side working separation. This makes it possible, for example, to achieve working distances of between 20 and 50 nm. If required, optical recorrection is advantageous, and can be carried out, for example, with the aid of suitable manipulators, on one or more lens elements, for example in order to adjust air gaps.

The invention thus also covers a non-contacting projection exposure method in which evanescent fields of the exposure light which are located in the immediate vicinity of the outlet surface can be used for the lithographic process. In this case, in sufficiently short (finite) working distances a light component which can be used for lithography to be emitted from the outlet surface of the objective and to be coupled into an inlet surface, which is immediately adjacent at a distance, despite geometric total internal reflection conditions on the vast optical surface of the projection objective.

Embodiments for non-contacting near-field projection lithography preferably have typical working distances in the region of the operating wavelength or less, for example between about 3 nm and about 200 nm, in particular between about 5 nm and about 100 nm. The working distance should be matched to the other characteristics of the projection system (characteristics of the projection objective close to the outlet surface, characteristics of the substrate close to the input surface) such that an input efficiency of at least 10% is achieved, averaged over time.

Within the scope of the invention, a method for producing semiconductor components and the like is thus possible, in which a finite working distance is set between an outlet surface (which is associated with the projection objective) for exposure light and an input surface (which is associated with the substrate) for exposure light, with the working distance being set within an exposure time interval, at least at times, to a value which is less than a maximum extent of an optical near field of the light emerging from the outlet surface.

Apart from this, projection objectives according to the invention can also be used as dry systems for conventional projection lithography. For this purpose, the image-side working distance may be considerably greater than during use as an immersion system or as a near-field projection system. Since, in this case, the full potential of very high image-side numerical apertures may in some circumstances not be exhausted, the system diaphragm can be set to a smaller diaphragm diameter in order, for example, to set a numerical aperture for use in the order of magnitude of NA=0.9, NA=0.8, or less.

The above features and further features are described not only in the claims but also in the description and in the drawings, in which case the individual features may each be implemented on their own or in combinations of two or more, in the form of subcombinations for embodiments of the invention, and in other fields, and may represent advantageous embodiments which can also be subject to protection in their own right.

### BRIEF DESCRIPTION OF THE DRAWINGS

FIG. 1 shows a first embodiment of a projection objective according to the invention with two catadioptric objective parts and a cruciform structure;

FIG. 2 shows a schematic illustration of a second embodiment of a projection objective according to the invention with a catadioptric objective part which can be aligned vertically;

FIG. 3 shows a lens section through a third embodiment of a projection objective according to the invention;

FIG. 4 shows a schematic illustration of a fourth embodiment of a projection objective according to the invention with a catadioptric objective part which can be aligned horizontally; and

FIG. 5 shows a lens section through a fifth embodiment of a projection objective according to the invention.

### DETAILED DESCRIPTION OF PREFERRED EMBODIMENTS

In the following description of preferred embodiments, the expression “optical axis” means a straight line or a sequence of straight line sections through the centers of curvature of the optical components. The optical axis is folded at folding mirrors (deflection mirrors) or other reflective surfaces. Directions and distances are described as being on the “image-side” when they point in the direction of the image plane or of the substrate to be exposed which is located there, and are described as being on the “object-side” when they point towards the object plane or to a reticle located there, with respect to the optical axis. In the examples, the object is a mask (reticle) with the pattern of an integrated circuit, although it may also be a different pattern, for example a grating. In the examples, the image is projected onto a wafer, which is provided with a photoresist layer and is used as a substrate. Other substrates, for example elements for liquid crystal displays or substrates for optical gratings, are also possible.

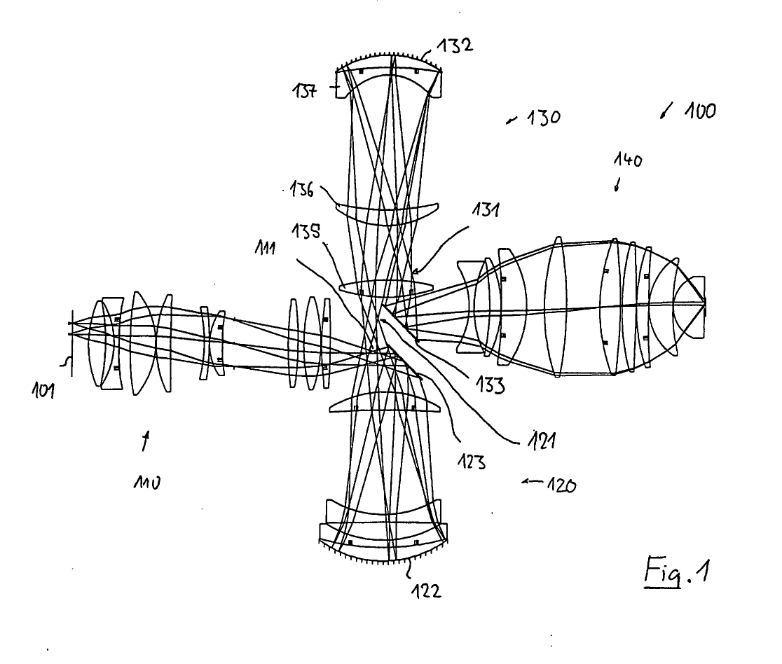

FIG. 1 shows a lens section through a first embodiment of a projection objective 100 which has a cruciform structure and has two coaxial catadioptric objective parts as well as two refractive objective parts which are arranged on the input side and output side of the objective. This is used to image a pattern, which is arranged on its object plane 101, of a mask on a reduced scale on its image plane 102, which is aligned parallel to the object plane. It comprises a first, refractive objective part 110, which images the object field in a first, real intermediate image 111, a second, catadioptric objective part 120 which images the first intermediate image in a second real intermediate image 121, a third, likewise catadioptric objective part 130, which images the second intermediate image in a real third intermediate image, and a fourth, refractive objective part, which images the third intermediate image 131 on the image plane 102 on a reduced scale. Each of the catadioptric objective parts has a concave mirror 122 or 132, respectively. Each of the concave mirrors has an associated planar folding mirror 123 or 133, respectively, which is used to disentangle the radiation passing to the concave mirror and from the concave mirror, that is to say for geometric beam splitting.

From the reticle, which is arranged on the object plane 101, the light passes through the first, refractive objective part 110 to a first folding mirror 123, which is located in the vicinity of the first intermediate image 111, and immediately behind it. The first folding mirror 123 reflects the radiation into the first catadioptric objective part 120, which points downwards in the drawing. This objective part can be aligned essentially horizontally during operation. Objective parts such as these are also referred to in the following text as a horizontal arm (HOA). The catadioptric objective part 120 images the light on the second intermediate image 121, which is located in the geometric area between the folding mirrors 123, 133 and the object plane 101. With this beam routing, the beam path which runs between the object plane 101 and the concave mirror 122 and the beam path which runs from the concave mirror to the image plane cross over in the vicinity of the first folding mirror 123, between it and the object plane. The second intermediate image 121 is located in the geometric vicinity of the folding mirrors 123, 133. The radiation coming from the second intermediate image then passes through the second catadioptric objective part 130, which is the upper objective part in the drawing and itself once again produces an intermediate image 131, which is the third intermediate image of the projection objective. The third intermediate image 131 is imaged directly, that is to say without any further intermediate image, on the image plane 102 by the fourth objective part 140, which is the second refractive objective part.

The following features are present and can be seen from the illustration: the design has three, and only three, real intermediate images. There are thus 3+1=4 possible positions of aperture diaphragms (real pupil positions), that is to say in the relay system 110, in the vicinity of the concave mirrors 122, 123 and in the fourth, refractive subsystem 140. In this specific exemplary embodiment, the aperture diaphragm 115 is located in the first refractive system 110.

The folding mirrors are located in the vicinity of the intermediate images, which minimizes the light transmittance level (the object is minimally off-axis). The intermediate images (that is to say the total area between the paraxial intermediate image and the marginal beam intermediate image) are not, however, located on the mirror surfaces, so that any faults in the mirror surfaces are not imaged sharply on the image plane.

One particular feature of the system is that a biconvex positive lens 135, which is passed through in two directions, is provided geometrically between the second folding mirror 130 and the concave mirror 132 in an area of the projection objective which is passed through twice, which positive lens 135 is passed through both in the light path between the second intermediate image 121 and the concave mirror 123 and in the light path between the concave mirror 132 and the second folding mirror 133, and the image plane 102, in lens areas which are offset with respect to one another. The positive lens 135 is arranged close to the field both with respect to the second intermediate image 121 and with respect to the third intermediate image 131, and thus acts as a field lens with respect to both intermediate images. The positive refractive power in the light path between the second intermediate image 121 and the concave mirror 132 ensures inter alia that the diameters of the downstream lenses 136, 137 and of the concave mirror 132 can be kept small. The positive refractive power in the light patch from the third intermediate image 131 to the image plane results in a reduction in the incidence angle bandwidth of the radiation which also strikes the second folding mirror 133, so that the second folding mirror 133 can be covered with advantageous reflex layers, and in order to limit the lens diameters in the refractive objective part 140 which is closest to the image field and is essentially responsible for producing the large image-side numerical aperture (NA=1.20) of the immersion projection objective.

The field lens 135, which is arranged in the immediate vicinity of two intermediate images 121, 131, also has major advantages with respect to optical correction, as will be explained in more detail in the following text. In principle, it is advantageous for the correction of imaging errors to have optical surfaces in the vicinity of intermediate images which are subject to severe aberration. The reason for this is as follows: at a long distance from the intermediate image, for example in the vicinity of the system diaphragm or its conjugate planes, all the diverging rays in a light beam have a finite and monotonally rising height with the pupil coordinate, that is to say an optical surface acts on all the diverging rays. Diverging rays which are located further outwards at the pupil margin also have an increasingly greater height on this surface (or, more correctly an increasing distance from the primary beam).

However, this is no longer the case in the vicinity of an intermediate image which is subject to severe aberration. If one is even within the caustic of the intermediate image, then it is possible for the surface to be approximately in or close to the marginal beam image, that is to say there is virtually no effect on the marginal beams, but there is a considerable optical effect on the zone beams. It is thus possible, for example, to correct a field zone error in the optical aberrations.

In the present exemplary embodiment, corrective optical surfaces (lens surfaces, some of which are also aspheric) are introduced into the beam path both before and after the third intermediate image 131, seen in the beam direction, specifically the surfaces of the positive meniscus lens 136 and the surfaces of the biconvex field lens 135. This improves the correction capability. A minor increase in the light guidance value in comparison to systems in which the intermediate image is located very close to the mirror surface without any intermediate lens may be tolerable when this advantage is borne in mind.

The folding angles in this specific exemplary embodiment are exactly 90°, in particular no greater than 90°. This is advantageous for the performance of the mirror layers of the folding mirrors (see below). Deflections through more than 90° are also possible, which then result in obliquely positioned horizontal arms.

The reticle plane 101 (plane of the object field) is not affected by the mounting technique. No cut-off lenses are required. The performance data for the system with a full field (26×5.5 mm²) and an NA of 1.2 allows relatively small maximum lens diameters (<300 mm), and thus a design which saves material.

The following features may each be advantageous either on their own or in conjunction with other features. The design includes four field lenses with positive refractive power, in each case in the immediate vicinity of the folding dummy. At least one negative lens should be provided in one of the two HOAs in order to ensure chromatic correction. At least one negative lens may be provided in each catadioptric part, preferably in the immediate vicinity of the concave mirror. Advantageous variants include at least three lenses which are passed through twice (in the illustrated exemplary embodiment, six lenses which are passed through twice are provided).

Advantageous variants include less negative refractive power in the refractive parts (in the exemplary embodiment, essentially one negative lens in the image-side refractive objective part 140).

The design has severe coma in the intermediate images, in particular in the third intermediate image 131. This helps to correct for the sine condition in the image area without surfaces with high incidence angles in the objective part 140.

The arrangement of the field lens 135 in the immediate optical vicinity of the severely aberrated third intermediate image 131 also very effectively assists optical correction, as stated above.

The specification of the design is summarized in tabular form in Table 1. In this case, column 1 indicates the number of the surface which is refractive, reflective or is distinguished in some other way, column 2 indicates the radius r of the surface (in mm), column 3 indicates the distance d, which is referred to as the thickness, between the surface and the next surface (in mm), column 4 indicates the material of a component, and column 5 indicates the refractive index of the material of the component which follows the indicated inlet surface. Column 6 indicates the optically usable half, free diameters of the optical components (in mm).

Table 2 indicates the corresponding aspheric data, with the arrow heights of the aspheric surfaces being calculated using the following rule:
p(h)=[((1/r)h²)/(1+SQRT(1−(1+K)(1/r)²h²)]+C1*h⁴+C2*h⁶+ . . .

In this case, the reciprocal (1/r) of the radius indicates the surface curvature at the surface apex, and h indicates the distance between a surface point and the optical axis. This arrow height is thus indicated by p(h) that is to say the distance between the surface point and the surface apex in the z direction, that is to say in the direction of the optical axis. The constants K, C1, C2 . . . are shown in Table 2.

In principle, different imaging scales of the projection objective are possible, in particular 4×, 5×, 6×. Larger imaging scales (for example 5× or 6×) may be better since they reduce the object-side aperture and thus reduce the load on the folding geometry.

The relay system 110 (first subsystem) need not necessarily have an imaging scale close to 1:1, nor need the catadioptric objective parts 120, 130. In this case, in particular, a magnifying first objective part 110 may be advantageous in order to reduce the load on the folding geometry.

The system shown in FIG. 1 is in the form of an immersion objective. By way of example, highly purified water may be used as the immersion medium for 193 nm. It is also possible to design projection objectives according to the invention as a dry objective, for example with an NA of 0.95, with a finite working distance on the wafer.

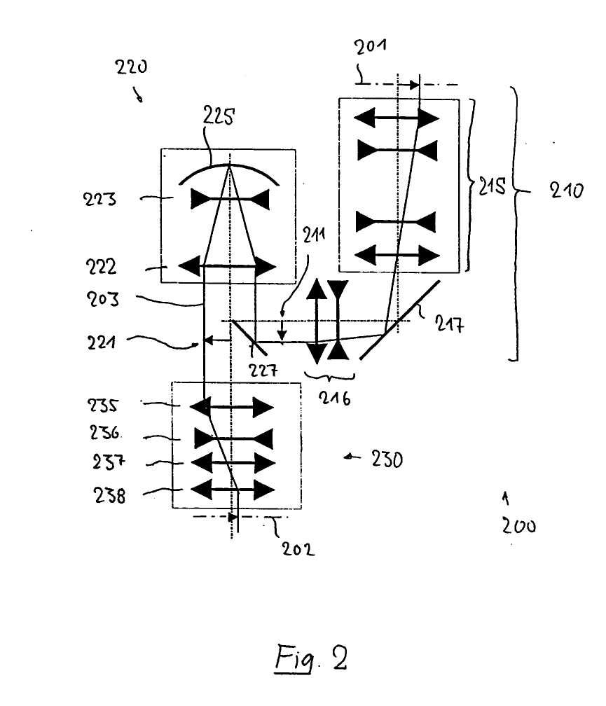

Embodiments of projection objectives according to the invention will be described with reference to FIGS. 2 to 5, each having two refractive objective parts and a catadioptric objective part located between them, with two and only two intermediate images being produced between the object plane and the image plane. Two mutually perpendicular folding mirrors are in each case provided, and allow the object plane and the image plane to be aligned parallel.

Between its object plane 201 and its first image plane 202, the projection objective 200 which is illustrated schematically in FIG. 2 has a first refractive object part 210 which produces a first intermediate image 211, a downstream catadioptric objective part 220 which images the first intermediate image 211 in a second intermediate image 221, and a downstream refractive objective part 230 which images the second intermediate image 221 directly, that is to say without any further intermediate image, on the image plane 202.

All of the objective parts have positive refractive power. In the schematic illustration, all of the individual lenses or lens groups with positive refractive power are represented by double-headed arrows with points pointing upwards, while, in contrast, individual lenses or lens groups with negative refractive power are represented by double-headed arrows with points pointing inwards.

The first objective part 210 comprises two lens groups 215, 216, between which a first folding mirror 217 is arranged. Between the lens groups 215, 216, there is a possible diaphragm position, where the primary beam 203 (which is represented by a solid line) intersects the optical axis 204 (which is represented by a dashed-dotted line). The optical axis is folded through 900 on the folding mirror 217, so that the first lens group 215 is aligned vertically, and the second lens group 216 is aligned horizontally, when the projection objective is in the installed state. The second lens group 216, which is arranged between the folding mirror 217 and the first intermediate image 211 and has a number of individual lenses with different refractive power (negative-positive), acts as a field lens owing to its optical proximity to the first image plane 211.

The first intermediate image 211 acts as an object for the downstream catadioptric objective part 220. This has a positive lens group 222 close to the field, a negative lens group 223 close to the diaphragm, and a concave mirror 225 arranged directly behind. The second folding mirror 227, which is required for geometric beam splitting, is arranged directly behind the first intermediate image 211 in order to deflect the radiation coming from the first objective part in the direction of the concave mirror 225. The lens group 222, which has a positive effect overall, has at least one positive lens whose effect may, however, also be provided by two or more lenses with positive refractive power overall. The negative lens group 223 comprises one or more lenses with a negative effect. At least one aspheric surface is located close to one possible diaphragm position in the catadioptric objective part, that is to say close to the concave mirror 225.

The second intermediate image 221, which is located in the immediate geometric vicinity of the second folding mirror 227, is imaged by the third, refractive objective part 230 on the image plane 202. The refractive objective part 230 has a first positive lens group 235, a second negative lens group 236, a third positive lens group 237 and a fourth positive lens group 238. One possible diaphragm position, where the primary beam intersects the optical axis, is located between the positive lens groups 237, 238.

The folding which is produced by the first folding mirror 217 within the first refractive objective part 210, in conjunction with the subsequent folding on the folding mirror 227, makes it possible for the catadioptric objective part 220 to be arranged with a vertical optical axis running parallel to the force of gravity direction. This optical axis thus runs parallel to the object-side section and to the image-side section of the optical axis. This therefore avoids deformation of the optical elements and mountings produced by the force of gravity, as can occur in conventional designs with catadioptric objective parts arranged horizontally or at an angle to the vertical. Imaging errors produced in this way are accordingly avoided, so that there is no need for appropriate compensation means.

A further special feature is the field lens group 216 between the first folding mirror 217 and the intermediate image 211. If required, this group may be moved close to the intermediate image 211 without being impeded by the folding mirrors 217, 227, thus allowing a major correction effect.

The second intermediate image 221 may be positioned in the immediate vicinity of the second folding mirror 227. This reduces the vignetting problem with this arrangement. The first folding mirror 217 is located in the vicinity of the possible diaphragm position in the first objective part. This has the advantage that the angle load is smaller, thus resulting in a reduction in the requirement for the layer design, and of negative effects caused by the reflection coating. Both the length of the system and the lateral offset between the object-side section of the optical axis and the image-side section of the optical axis, that is to say in fact the object image shift, can be adjusted by moving the first folding mirror 217. The relatively long first objective part 210 allows a design with reduced loads.

The imaging scale β of the catadioptric objective part 220 is subject to the condition IβI>1. The reticle is illuminated with polarized light. The two or three lenses closest to the image can be made of calcium fluoride in order to avoid compaction problems. In order to compensate for intrinsic birefringence, the crystallographic primary axes of the lenses may be rotated with respect to one another. The concave mirror 295 may be in the form of an active mirror in which the shape of the mirror surface can be varied by means of suitable manipulators. This can be used to compensate for various imaging errors. The beam path in the vicinity of at least one of the intermediate images is virtually telecentric.

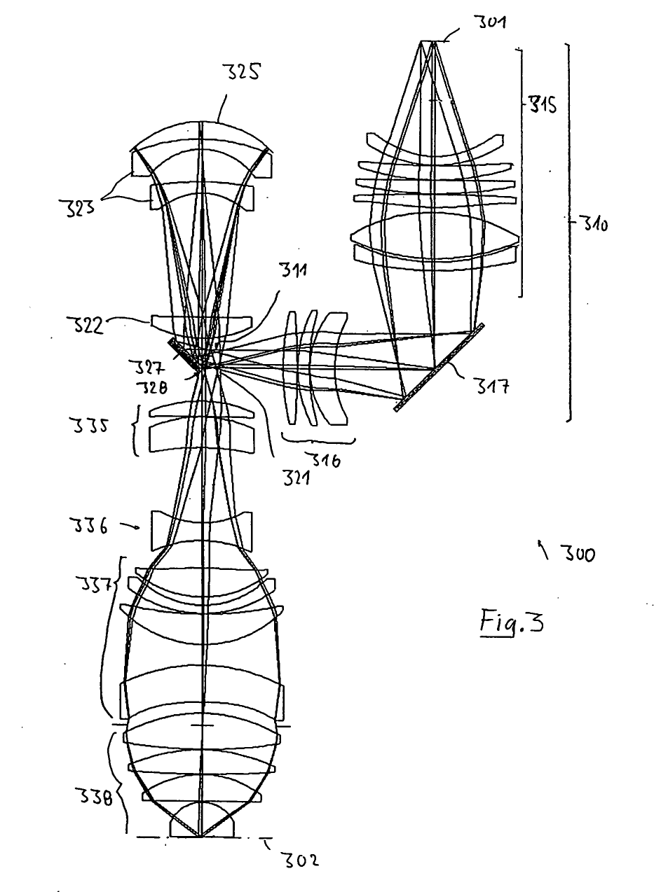

FIG. 3 shows a lens section of a projection objective 300 which is essentially designed using the principles explained with reference to FIG. 2. Identical or corresponding elements or element groups are annotated with the same reference symbols as those in FIG. 2, increased by 100. The specification for this exemplary embodiment is shown in Tables 3 and 4. The projection objective 300 is designed for an operating wavelength of about 193 nm, and has an image-side numerical aperture NA of 1.2, which can be achieved when using an immersion medium, for example very pure water.

A comparison between the beam profiles of the systems in FIG. 2 and FIG. 3 shows that different beam routes are possible within this design variant. The system in FIG. 2 has a beam path without a crossing, since a first beam section which runs from the object plane to the concave mirror and a second beam section which runs from the concave mirror to the image plane do not intersect anywhere. In contrast, the beam routes in the embodiment shown in FIG. 3 cross in the area of the second folding mirror 327. In this embodiment, the second folding mirror 327 is arranged on the side of the optical axis of the catadioptric objective part facing away from the first folding mirror 317. A first beam section which runs from the object plane 301 to the concave mirror 325 and a second beam section which runs from the concave mirror 325 to the image plane 302 therefore cross in the area immediately in front of the mirror surface of the second folding mirror 327 in the vicinity of the first intermediate image 311 and of the second intermediate image 321. In this case, the first intermediate image 311 is located in the immediate optical vicinity of the second folding mirror 327, while the second intermediate image 321 is located in the immediate geometric vicinity of the inner mirror edge 328, which faces the optical axis, of the second folding mirror 327. This crossed beam routing allows optimization of the light guidance value, since a very short distance can be set between the off-axis object field and the optical axis.

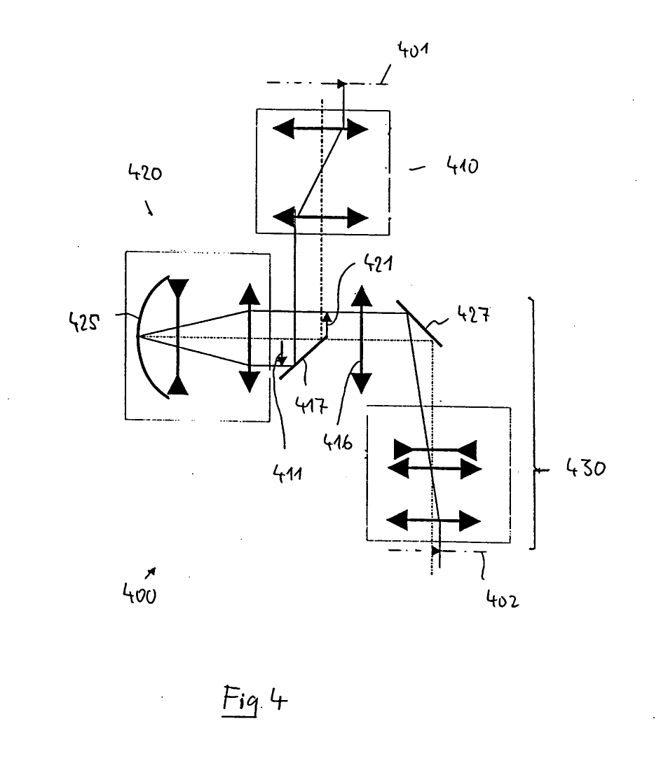

FIG. 4 shows a fourth embodiment of the projection objective 400. Identical or corresponding elements or element groups are annotated with the same reference symbols as in FIG. 2, increased by 200.

The refractive first objective part 410 images the object field on a first intermediate image 411, which is located downstream from the first folding mirror 417 in the beam direction. This is thus arranged within the first refractive objective part 410, in its end area. The catadioptric objective part 420 images the first intermediate image 411 on a second intermediate image 421, which is located geometrically between a mirror edge close to the axis of the first folding mirror 417 and the object plane, in the immediate vicinity of this mirror edge. The second intermediate image is imaged by a third, refractive objective part 430 on the image plane 402, without any further intermediate image. This objective part has a second folding mirror 427 arranged between the first and the last lens of the objective part, so that the optical axis is folded within the refractive objective part.

A comparison to the previous embodiments shows the following special features. The catadioptric objective part 420 is arranged with a horizontal optical axis. The beam routes cross, with the beam section which runs from the image plane to the concave mirror 425 crossing the beam section which runs from the concave mirror to the image plane in the vicinity of the first folding mirror 417. In comparison to the embodiment shown in FIG. 2, the field lens group 416, which is located between the second intermediate image 421 and the second folding mirror 427, is positioned closer to the second intermediate image. The second folding mirror is further away from the intermediate image. This modification means that the field lens group 416 can have a stronger effect on field aberrations and on reducing the beam diameter of the downstream lens groups. The second folding mirror 427 has a smaller incidence angle load, thus allowing a layer design with reduced loads. The second intermediate image 421 is located directly close to the first folding mirror, but is not intersected by it. This allows optimum setting of the light guidance value and, on the other hand, optimum setting of the image scale of the catadioptric objective part 420.

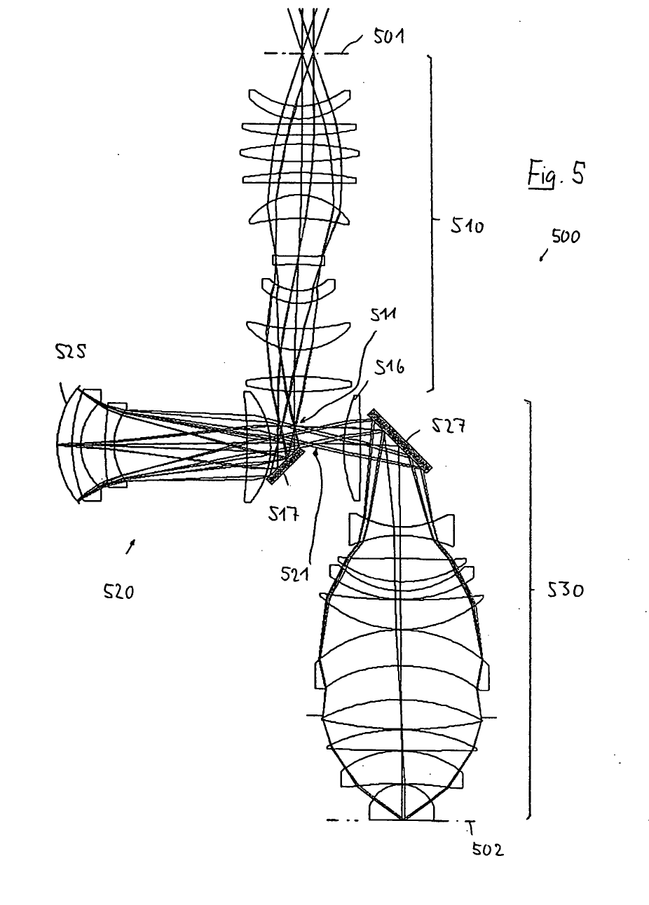

FIG. 5 shows a lens section illustration of a projection objective 500, which is designed on the basis of similar design principles. In comparison to FIG. 4, identical or corresponding elements are annotated by reference symbols increased by 100. The specification of this projection objective is defined in Tables 5 and 6. The system is designed for an operating wavelength of 157 nm, and has an image-side numerical aperture NA=1.2 when a suitable immersion liquid is used. The imaging scale is β=0.25.

As can be seen, the beam routes cross in this case as well. A single, biconvex positive lens 516 is arranged between the second intermediate image 521 and the second folding mirror 527, acts as a field lens with respect to the second intermediate image 521, and reduces the incidence angle bandwidth of the radiation striking the second folding mirror 527.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

TABLE 1

| Surface | Radius | Thickness | Material | Index | ½ Diam. |
|---|---|---|---|---|---|
| 1 | 0.000000 | 0.000000 | AIR | | 78.6 |
| 2 | 228.289554 | 34.623340 | SIO2 | 1.5608 | 83.1 |
| 3 | −311.577418 | 14.561124 | AIR | | 83.6 |
| 4 | −156.703941 | 9.498712 | SIO2 | 1.5608 | 83.3 |
| 5 | 437.339276 | 38.336185 | AIR | | 90.3 |
| 6 | 817.428832 | 55.612541 | SIO2 | 1.5608 | 107.1 |
| 7 | −163.343955 | 0.948285 | AIR | | 109.5 |
| 8 | 159.581733 | 45.231026 | SIO2 | 1.5608 | 103.5 |
| 9 | 45720.795520 | 60.921465 | AIR | | 100.5 |
| 10 | −510.003653 | 9.497933 | SIO2 | 1.5608 | 70.1 |
| 11 | 322.795114 | 0.945232 | AIR | | 65.0 |
| 12 | 104.532530 | 30.001096 | SIO2 | 1.5608 | 61.3 |
| 13 | 501.572695 | 16.746494 | AIR | | 54.2 |
| STO | 0.000000 | 104.108509 | AIR | | 44.8 |
| 15 | 661.975194 | 38.605308 | SIO2 | 1.5608 | 88.0 |
| 16 | −170.712471 | 0.947688 | AIR | | 89.7 |
| 17 | 1128.414689 | 22.420608 | SIO2 | 1.5608 | 88.4 |
| 18 | −298.395983 | 58.559155 | AIR | | 88.2 |
| 19 | 0.000000 | 51.438092 | AIR | | 77.4 |
| 20 | 0.000000 | −99.616638 | REFL | | 143.1 |
| 21 | −208.690229 | −41.575982 | SIO2 | 1.5608 | 112.8 |
| 22 | −3580.266450 | −270.641389 | AIR | | 112.3 |
| 23 | 157.030000 | −15.000000 | SIO2 | 1.5608 | 111.9 |
| 24 | 5508.981110 | −39.486877 | AIR | | 130.0 |
| 25 | 251.459194 | −15.000000 | SIO2 | 1.5608 | 132.5 |
| 26 | 452.403398 | −28.741339 | AIR | | 145.7 |
| 27 | 229.747686 | 28.741339 | REFL | | 148.2 |
| 28 | 452.403398 | 15.000000 | SIO2 | 1.5608 | 145.7 |
| 29 | 251.459194 | 39.486877 | AIR | | 132.5 |
| 30 | 6508.981110 | 15.000000 | SIO2 | 1.5608 | 130.0 |
| 31 | 157.030000 | 270.541389 | AIR | | 111.9 |
| 32 | −3580.266450 | 41.575982 | SIO2 | 1.5608 | 112.3 |
| 33 | −208.690229 | 99.616638 | AIR | | 112.8 |
| 34 | 0.000000 | 45.753926 | AIR | | 114.7 |
| 35 | 0.000000 | 24.951873 | AIR | | 78.5 |
| 36 | 0.000000 | 20.000000 | AIR | | 150.9 |
| 37 | 304.303270 | 30.635227 | SIO2 | 1.5608 | 87.3 |
| 38 | −376.275745 | 113.308441 | AIR | | 87.2 |
| 39 | 174.612807 | 30.000179 | SIO2 | 1.5608 | 95.0 |
| 40 | 442.574287 | 260.415977 | AIR | | 94.0 |
| 41 | −109.453533 | 15.000000 | SIO2 | 1.5608 | 93.9 |
| 42 | −634.654587 | 28.693730 | AIR | | 116.5 |
| 43 | −193.109781 | −28.693730 | REFL | | 118.2 |
| 44 | −634.654587 | −15.000000 | SIO2 | 1.5608 | 116.5 |
| 45 | −109.453533 | −260.415977 | AIR | | 93.9 |
| 46 | 442.674287 | −30.000179 | SIO2 | 1.5608 | 94.0 |
| 47 | 174.612807 | −56.221615 | AIR | | 95.0 |
| 48 | 0.000000 | −57.085144 | AIR | | 82.5 |
| 49 | −376.275745 | −30.635227 | SIO2 | 1.5608 | 87.2 |
| 50 | 304.303270 | −20.000000 | AIR | | 87.3 |
| 51 | 0.000000 | 161.182885 | REFL | | 115.8 |
| 52 | −134.338619 | 9.499900 | SIO2 | 1.5608 | 81.0 |
| 53 | 241.910230 | 29.909047 | AIR | | 92.6 |
| 54 | −3137.023905 | 30.552311 | SIO2 | 1.5608 | 102.0 |
| 55 | −247.871499 | 18.739324 | AIR | | 106.4 |
| 56 | 7353.093456 | 51.805948 | SIO2 | 1.5808 | 123.9 |
| 57 | −213.134356 | 0.957989 | AIR | | 129.3 |
| 58 | 470.290190 | 41.920015 | SIO2 | 1.5608 | 140.5 |
| 59 | −1196.560207 | 59.517279 | AIR | | 140.5 |
| 60 | 337.259718 | 49.738324 | SIO2 | 1.5608 | 134.9 |
| 61 | −781.435164 | 0.949831 | AIR | | 133.4 |
| 62 | 626.161104 | 22.556042 | SIO2 | 1.5608 | 128.3 |
| 63 | −26080.540935 | 0.954018 | AIR | | 126.7 |
| 64 | 522.604588 | 29.998994 | SIO2 | 1.5608 | 122.8 |
| 65 | −2252.799389 | 6.113819 | AIR | | 119.6 |
| 66 | 130.003864 | 49.978003 | SIO2 | 1.5608 | 98.1 |
| 67 | 909.197529 | 0.948917 | AIR | | 90.2 |
| 68 | 62.437080 | 56.576406 | CAF2 | 1.5019 | 57.2 |
| 69 | 0.000000 | 3.000000 | H2O | 1.4367 | 23.9 |

TABLE 2

| | 6 | 13 | 17 | 22 | 26 | 28 | 32 |
|---|---|---|---|---|---|---|---|
| K | 0 | 0 | 0 | 0 | 0 | 0 | 0 |
| C1 | 5.444045E−08 | 2.736006E−07 | −5.634029E−08 | −1.388976E−08 | 8.561203E−09 | 8.561203E−09 | −1.388976E−08 |
| C2 | −1.099004E−12 | −4.264707E−13 | 1.127672E−12 | −1.511268E−14 | −1.401814E−14 | −1.401814E−14 | −1.511268E−14 |
| C3 | −2.635458E−17 | 9 944233E−16 | −8.624584E−17 | 1.524614E−18 | 1.691102E−18 | 1.591102E−18 | 1.524614E−18 |
| C4 | 4.985586E−21 | −1.209975E−19 | 3.803812E−21 | 1.499803E−22 | −4.615764E−24 | −4.515764E−24 | 1.499803E−22 |
| C5 | −5.664742E−25 | −6.529470E−23 | −1.890720E−25 | −1.238915E−27 | 1.594741E−28 | 1.594741E−28 | −1.238915E−27 |
| C6 | 2.053829E−29 | 2.014814E−27 | 3.556950E−30 | −1.113795E−31 | 7.590771E−33 | 7.590771E−33 | −1.113795E−31 |
| | 37 | 42 | 44 | 50 | 56 | 60 | 65 |
| K | 0 | 0 | 0 | 0 | 0 | 0 | 0 |
| C1 | −2.555342E−05 | −1.723191E−08 | −1.723191E−08 | −2.555342E−08 | −2.781730E−08 | −3.022819E−08 | −1.392362E−08 |
| C2 | 2.570031E−13 | 4.434955E−13 | 4.434955E−13 | 2.570031E−13 | 1.632245E−13 | 4.721134E−14 | 1.118958E−12 |
| C3 | −9.143688E−18 | −1.663029E−17 | −1.663029E−17 | −9.143688E−18 | 3.252121E−18 | 1.569871E−17 | −3.152689E−17 |
| C4 | 7.342989E−22 | 5.776819E−22 | 5.776819E−22 | 7.342989E−22 | −6.457946E−22 | −2.773306E−22 | 1.837180E−21 |
| C5 | −6 600268E−26 | −1.425016E−26 | −1.425016E−26 | −6.800268E−26 | 1.277560E−26 | 1.220122E−26 | −5.722883E−26 |
| C6 | 2.618961E−30 | 1.712370E−31 | 1.712370E−31 | 2.618961E−30 | −5.121032E−31 | −2.543363E−31 | 1.332981E−30 |

TABLE 3

| Surface | Radius | Thickness | Material | Index | ½ Diam. | |
|---|---|---|---|---|---|---|
| 0 | 0.000000000 | 104.741242115 | | 1.00000000 | 57.597 | |
| 1 | 0.000000000 | 98.986787561 | | 1.00000000 | 88.408 | |
| 2 | −144.869651642 | 15.440300727 | SIO2V | 1.56078570 | 106.344 | |
| 3 | −212.865816329 | 0.999823505 | | 1.00000000 | 115.852 | |
| 4 | −1454.207505710 | 25.005408395 | SIO2V | 1.56078570 | 126.560 | |
| 5 | −430.323976548 | 0.999976542 | | 1.00000000 | 129.295 | |
| 6 | −13174.815871600 | 23.580658841 | SIO2V | 1.56078570 | 133.850 | |
| 7 | −677.066705707 | 1.000139508 | | 1.00000000 | 135.398 | |
| 8 | 2309.277803360 | 22.917962037 | SIO2V | 1.56078570 | 137.546 | |
| 9 | −498.340462541 | 9.117143141 | | 1.00000000 | 138.066 | |
| 10 | 279.211879797 | 81.301468318 | SIO2V | 1.56078570 | 143.044 | |
| 11 | −367.644767359 | 6.030929669 | | 1.00000000 | 140.905 | |
| 12 | −342.105872772 | 15.001391628 | SIO2V | 1.56078570 | 137.700 | |
| 13 | −590.097118798 | 175.000000000 | | 1.00000000 | 133.620 | |
| 14 | 0.000000000 | −175.046230114 | | −1.00000000 | 98.878 | REFL |
| 15 | 220.074763838 | −44.493977604 | SIO2V | −1.56078570 | 86.972 | |
| 16 | 159.078413847 | −1.055515355 | | −1.00000000 | 96.599 | |
| 17 | 366.765054416 | −20.396859002 | SIO2V | −1.56078570 | 97.739 | |
| 18 | 222.535975376 | −1.057731080 | | −1.00000000 | 99.135 | |
| 19 | −1186.790199210 | −24.502406754 | SIO2V | −1.56078570 | 97.299 | |
| 20 | 524.311494393 | −144.048010234 | | −1.00000000 | 96.564 | |
| 21 | 0.000000000 | 0.000000000 | | 1.00000000 | 88.237 | REFL |
| 22 | 0.000000000 | 51.573802546 | | 1.00000000 | 73.637 | |
| 23 | 197.497772927 | 36.574067296 | SIO2V | 1.56078570 | 84.574 | |
| 24 | 2439.719185840 | 218.388757699 | | 1.00000000 | 83.794 | |
| 25 | −105.775050349 | 20.188816733 | SIO2V | 1.56078570 | 76.925 | |
| 26 | −573.063680333 | 57.435493922 | | 1.00000000 | 87.532 | |
| 27 | −112.803507463 | 18.234987492 | SIO2V | 1.56078570 | 92.463 | |
| 28 | −301.122713345 | 30.774500841 | | 1.00000000 | 118.829 | |
| 29 | −173.189975733 | −30.774500841 | | −1.00000000 | 122.333 | REFL |
| 30 | −301.122713345 | −18.234987492 | SIO2V | −1.56078570 | 117.191 | |
| 31 | −112.803507463 | −57.435493922 | | −1.00000000 | 86.613 | |
| 32 | −573.063680333 | −20.188816733 | SIO2V | −1.56078570 | 76.903 | |
| 33 | −105.775050349 | −218.388757699 | | −1.00000000 | 68.019 | |
| 34 | 2439.719185840 | −36.574057295 | SIO2V | −1.56078570 | 71.871 | |
| 35 | 197.497772927 | −32.128980769 | | −1.00000000 | 72.689 | |
| 36 | 0.000000000 | 0.000000000 | | −1.00000000 | 73.394 | |
| 37 | 0.000000000 | −79.997987819 | | −1.00000000 | 73.394 | |
| 38 | −223.154870563 | −27.167625605 | SIO2V | −1.56078570 | 88.304 | |
| 39 | −2631.902211310 | −1.001181158 | | −1.00000000 | 88.411 | |
| 40 | −216.882615704 | −54.869511542 | SIO2V | −1.56078570 | 89.081 | |
| 41 | −525.140626049 | −132.082724214 | | −1.00000000 | 83.160 | |
| 42 | 155.953239642 | −31.729928145 | SIO2V | −1.56078570 | 74.429 | |
| 43 | −206.142967799 | −48.223711611 | | −1.00000000 | 85.407 | |
| 44 | −773.549140912 | −51.446361990 | SIO2V | −1.56078570 | 107.795 | |
| 45 | 181.955695079 | −14.548908000 | | −1.00000000 | 112.437 | |
| 46 | 158.359096586 | −14.999760113 | SIO2V | −1.56078570 | 113.852 | |
| 47 | 210.310379418 | −1.000182345 | | −1.00000000 | 125.070 | |
| 48 | 575.360853037 | −54.192760002 | SIO2V | −1.55078570 | 135.358 | |
| 49 | 193.453123929 | −36.653786142 | | −1.00000000 | 139.167 | |
| 50 | −310.676706807 | −64.547823782 | SIO2V | −1.55078570 | 139.788 | |
| 51 | −461.033067920 | −41.794838320 | | −1.00000000 | 129.103 | |
| 52 | 0.000000000 | 0.000000000 | | −1.00000000 | 130.538 | |
| 53 | 0.000000000 | 21.781053165 | | −1.00000000 | 130.550 | |
| 54 | −271.029644892 | −63.749677013 | SIO2V | −1.56078570 | 133.561 | |
| 55 | 787.927951021 | −0.999615388 | | −1.00000000 | 132.544 | |
| 56 | −306.845228442 | −42.985386714 | SIO2V | −1.56078570 | 125.041 | |
| 57 | 1760.258861380 | −0.999675387 | | −1.00000000 | 121.634 | |
| 58 | −173.404012939 | −47.056716890 | SIO2V | −1.56078570 | 101.653 | |
| 59 | −12605.600882500 | −2.451247055 | | −1.00000000 | 92.624 | |
| 60 | −61.916082179 | −61.950031522 | CAF2V | −1.50185255 | 54.036 | |
| 61 | 0.000000000 | 0.000000000 | CAF2V | −1.50185255 | 14.442 | |
| 62 | 0.000000000 | 0.000000000 | | −1.00000000 | 14.442 | |

TABLE 4
Aspheric constants
Surface No. 2

| | |
|---|---|
| K | 0.0000 |
| C1 | 4.26173375e−008 |
| C2 | 4.98737905e−013 |
| C3 | 3.42519730e−018 |
| C4 | 3.06018084e−021 |
| C5 | −7.06828534e−026 |
| C6 | 7.81151846e−030 |
| C7 | 0.00000000e+000 |
| C8 | 0.00000000e+000 |
| C9 | 0.00000000e+000 |

Surface No. 9

| | |
|---|---|
| K | 0.0000 |
| C1 | 3.63077093e−008 |
| C2 | −5.76212004e−013 |
| C3 | 1.45903234e−017 |
| C4 | −1.85421876e−022 |
| C5 | 3.65939239e−027 |
| C6 | −5.77160132e−032 |
| C7 | 0.00000000e+000 |
| C8 | 0.00000000e+000 |
| C9 | 0.00000000e+000 |

Surface No. 15

| | |
|---|---|
| K | 0.0000 |
| C1 | 7.03322881e−008 |
| C2 | −1.98459369e−012 |
| C3 | 2.72073809e−017 |
| C4 | 1.62470767e−021 |
| C5 | −2.18810306e−025 |
| C6 | 7.00912386e−030 |
| C7 | 0.00000000e+000 |
| C8 | 0.00000000e+000 |
| C9 | 0.00000000e+000 |

Surface No. 20

| | |
|---|---|
| K | 0.0000 |
| C1 | 2.06864626e−008 |
| C2 | −1.02213589e−012 |
| C3 | 9.52192505e−016 |
| C4 | 1.11822927e−021 |
| C5 | −7.99753889e−026 |
| C6 | 2.04067789e−030 |
| C7 | 0.00000000e+000 |
| C8 | 0.00000000e+000 |
| C9 | 0.00000000e+000 |

Surface No. 23

| | |
|---|---|
| K | 0.0000 |
| C1 | 1.09083053e−008 |
| C2 | 4.75804524e−014 |
| C3 | −1.03460635e−017 |
| C4 | −4.95298271e−022 |
| C5 | 5.91815317e−026 |
| C6 | −2.20505862e−030 |
| C7 | 0.00000000e+000 |
| C8 | 0.00000000e+000 |
| C9 | 0.00000000e+000 |

Surface No. 25

| | |
|---|---|
| K | 0.0000 |
| C1 | 8.51264359e−008 |
| C2 | 2.92721550e−012 |
| C3 | 2.10716478e−016 |
| C4 | 3.50996943e−020 |
| C5 | −1.60192133e−024 |
| C6 | 6.41085946e−028 |
| C7 | 0.00000000e−000 |
| C8 | 0.00000000e+000 |
| C9 | 0.00000000e+000 |

Surface No. 33

| | |
|---|---|
| K | 0.0000 |
| C1 | 8.51264359e−008 |
| C2 | 2.92721550e−012 |
| C3 | 2.10716478e−016 |
| C4 | 3.50996943e−020 |
| C5 | −1.60192133e−024 |
| C6 | 5.41085945e−028 |
| C7 | 0.00000000e+000 |
| C8 | 0.00000000e+000 |
| C9 | 0.00000000e+000 |

Surface No. 35

| | |
|---|---|
| K | 0.0000 |
| C1 | 1.09083053e−008 |
| C2 | 4.75804524e−014 |
| C3 | −1.03460635e−017 |
| C4 | −4.95298271e−022 |
| C5 | 5.91815317e−026 |
| C6 | −2.20505862e−030 |
| C7 | 0.00000000e+000 |
| C8 | 0.00000000e+000 |
| C9 | 0.00000000e+000 |

Surface No. 41

| | |
|---|---|
| K | 0.0000 |
| C1 | −3.26193494e−008 |
| C2 | 6.43030494e−013 |
| C3 | 1.49241431e−017 |
| C4 | 2.11260462e−021 |
| C5 | −3.66895167e−025 |
| C6 | 1.58872843e−029 |
| C7 | 0.00000000e+000 |
| C8 | 0.00000000e+000 |
| C9 | 0.00000000e+000 |

Surface No. 42

| | |
|---|---|
| K | 0.0000 |
| C1 | 5.27051153e−008 |
| C2 | −5.60900125e−012 |
| C3 | 3.85338688e−017 |
| C4 | 2.41720014e−020 |
| C5 | −4.24632866e−024 |
| C6 | 7.46022591e−028 |
| C7 | 0.00000000e+000 |
| C8 | 0.00000000e+000 |
| C9 | 0.00000000e+000 |

Surface No. 44

| | |
|---|---|
| K | 0.0000 |
| C1 | 3.17825723e−008 |
| C2 | 1.13029860e−012 |
| C3 | −6.23316850e−017 |
| C4 | 3.79163301e−021 |
| C5 | −1.16775305e−025 |
| C6 | 2.92133783e−030 |
| C7 | 0.00000000e+000 |
| C8 | 0.00000000e+000 |
| C9 | 0.00000000e+000 |

Surface No. 51

| | |
|---|---|
| K | 0.0000 |
| C1 | −4.31716306e−008 |
| C2 | −1.25785464e−013 |
| C3 | 4.01188994e−019 |
| C4 | 1.15628808e−022 |
| C5 | 1.16755615e−026 |
| C6 | −3.12741849e−031 |
| C7 | 0.00000000e+000 |
| C8 | 0.00000000e+000 |
| C9 | 0.00000000e+000 |

Surface No. 59

| | |
|---|---|
| K | 0.0000 |
| C1 | −3.61295869e−009 |
| C2 | −1.50384476e−012 |
| C3 | 1.39525878e−018 |
| C4 | −1.05872711e−020 |
| C5 | 4.85583819e−025 |
| C6 | −1.15860942e−029 |
| C7 | 0.00000000e+000 |
| C8 | 0.00000000e+000 |
| C9 | 0.00000000e+000 |

TABLE 5

| | | | | Index | | |
|---|---|---|---|---|---|---|
| Surface | Radius | Thickness | Material | 157.2862 nm | ½ Diam. | |
| 0 | 0.000000000 | 53.340699544 | | 1.00000000 | 57.697 | |
| 1 | 0.000000000 | 42.732271910 | | 1.00000000 | 73.828 | |
| 2 | −119.875082094 | 22.748523326 | CAF2HL | 1.55930394 | 78.588 | |
| 3 | −128.004442219 | 8.632050483 | | 1.00000000 | 86.110 | |
| 4 | 9145.390980430 | 20.549098047 | CAF2HL | 1.55930394 | 96.152 | |
| 5 | −485.955922859 | 15.942283284 | | 1.00000000 | 97.634 | |
| 6 | 498.475853574 | 31.214804153 | CAF2HL | 1.55930394 | 101.808 | |
| 7 | −498.475853574 | 19.694464026 | | 1.00000000 | 101.783 | |
| 8 | 587.148568621 | 18.421491986 | CAF2HL | 1.55930394 | 97.120 | |
| 9 | −1225.333009930 | 20.636503986 | | 1.00000000 | 95.743 | |
| 10 | 108.773386959 | 40.971325827 | CAF2HL | 1.55930394 | 84.960 | |
| 11 | 341.514003351 | 65.844060840 | | 1.00000000 | 80.199 | |
| 12 | −1080.872986000 | 15.000000000 | CAF2HL | 1.55930394 | 44.005 | |
| 13 | 681.929797170 | 45.941835511 | | 1.00000000 | 42.771 | |
| 14 | −78.910061176 | 22.207725321 | CAF2HL | 1.55930394 | 51.100 | |
| 15 | −92.536976631 | 45.319966802 | | 1.00000000 | 61.495 | |
| 16 | −309.828184122 | 37.883613390 | CAF2HL | 1.55930394 | 84.202 | |
| 17 | −119.348677796 | 47.507290043 | | 1.00000000 | 88.060 | |
| 18 | 551.327205617 | 26.411986521 | CAF2HL | 1.55930394 | 89.684 | |
| 19 | −473.014730107 | 99.000000002 | | 1.00000000 | 89.219 | |
| 20 | 0.000000000 | 0.000000000 | | 1.00000000 | 85.697 | |
| 21 | 0.000000000 | −49.000000000 | | −1.00000000 | 100.904 | REFL |
| 22 | −140.848831219 | −41.499891067 | CAF2HL | −1.55930394 | 94.843 | |
| 23 | −795.006284416 | −232.839293241 | | −1.00000000 | 93.019 | |
| 24 | 101.644536051 | −15.000000000 | CAF2HL | −1.55930394 | 65.402 | |
| 25 | 540.350071063 | −42.562836179 | | −1.00000000 | 71.896 | |
| 26 | 101.288207215 | −15.000000000 | CAF2HL | −1.55930394 | 76.396 | |
| 27 | 251.413952599 | −26.192483166 | | −1.00000000 | 94.978 | |
| 28 | 157.091552225 | 26.192483166 | | 1.00000000 | 101.282 | REFL |
| 29 | 251.413952599 | 15.000000000 | CAF2HL | 1.55930394 | 94.572 | |
| 30 | 101.288207215 | 42.562836179 | | 1.00000000 | 75.327 | |
| 31 | 540.350071063 | 15.000000000 | CAF2HL | 1.55930394 | 71.987 | |
| 32 | 101.644536051 | 232.839293241 | | 1.00000000 | 65.407 | |
| 33 | −795.006284416 | 41.499891057 | CAF2HL | 1.55930394 | 90.030 | |
| 34 | −140.848831219 | 49.000000133 | | 1.00000000 | 91.948 | |
| 35 | 0.000000000 | 0.000000000 | | 1.00000000 | 85.691 | |
| 36 | 0.000000000 | 79.902361444 | | 1.00000000 | 85.691 | |
| 37 | 241.760560583 | 29.346805930 | CAF2HL | 1.55930394 | 89.861 | |
| 38 | −1732.062186670 | 72.000000000 | | 1.00000000 | 89.660 | |
| 39 | 0.000000000 | −138.000000000 | | −1.00000000 | 96.371 | REFL |
| 40 | 140.724679285 | −15.000000000 | CAF2HL | −1.55930394 | 79.100 | |
| 41 | −219.113421581 | −40.947239549 | | −1.00000000 | 88.485 | |
| 42 | −1542.369627010 | −41.755135106 | CAF2HL | −1.55930394 | 103.908 | |
| 43 | 191.495556469 | −16.392452991 | | −1.00000000 | 108.132 | |
| 44 | 155.337526341 | −15.000000000 | CAF2HL | −1.55930394 | 109.720 | |
| 45 | 216.294974584 | −1.000000000 | | −1.00000000 | 122.225 | |
| 46 | 1001.460301220 | −52.409597205 | CAF2HL | −1.55930394 | 136.624 | |
| 47 | 204.817980975 | −1.000000000 | | −1.00000000 | 139.169 | |
| 48 | −220.609411502 | −63.529777114 | CAF2HL | −1.55930394 | 148.138 | |
| 49 | −345.394088465 | −88.319074839 | | −1.00000000 | 135.854 | |
| 50 | 0.000000000 | 0.000000000 | | −1.00000000 | 138.956 | |
| 51 | 0.000000000 | 28.245852593 | | −1.00000000 | 138.977 | |
| 52 | −302.709726278 | −51.978992988 | CAF2HL | −1.55930394 | 139.716 | |
| 53 | 648.916626400 | −1.000000000 | | −1.00000000 | 139.465 | |
| 54 | −289.821251350 | −36.320694383 | CAF2HL | −1.55930394 | 127.299 | |
| 55 | 14450.590295700 | −1.000000000 | | −1.00000000 | 125.177 | |
| 56 | −169.908375503 | −58.650152492 | CAF2HL | −1.55930394 | 103.786 | |
| 57 | −783.734380809 | −1.000000000 | | −1.00000000 | 84.961 | |
| 58 | −59.783732235 | −64.469456233 | CAF2HL | −1.55930394 | 54.021 | |
| 59 | 0.000000000 | 0.000000000 | CAF2HL | −1.55930394 | 14.426 | |
| 60 | 0.000000000 | 0.000000000 | | −1.00000000 | 14.426 | |

TABLE 6
Aspheric constants
Surface No. 2

| | |
|---|---|
| K | 0.0000 |
| C1 | 2.79186484e−008 |
| C2 | 2.75720532e−012 |
| C3 | 1.40812686e−016 |
| C4 | 1.01283068e−020 |
| C5 | −1.87800533e−025 |
| C6 | 9.92028248e−029 |
| C7 | 0.00000000e+000 |
| C8 | 0.00000000e+000 |
| C9 | 0.00000000e+000 |

Surface No. 9

| | |
|---|---|
| K | 0.0000 |
| C1 | 3.89385077e−008 |
| C2 | 2.22702677e−013 |
| C3 | 4.57450465e−018 |
| C4 | −1.15266557e−021 |
| C5 | 9.48566237e−026 |
| C6 | −3.77376927e−030 |
| C7 | 0.00000000e+000 |
| C8 | 0.00000000e+000 |
| C9 | 0.00000000e+000 |

Surface No. 14

| | |
|---|---|
| K | 0.0000 |
| C1 | −1.29890372e−007 |
| C2 | −1.37902065e−011 |
| C3 | −2.22266049e−015 |
| C4 | −5.48956557e−019 |
| C5 | 3.64075458e−023 |
| C6 | −3.04700582e−028 |
| C7 | 0.00000000e+000 |
| C8 | 0.00000000e+000 |
| C9 | 0.00000000e+000 |

Surface No. 19

| | |
|---|---|
| K | 0.0000 |
| C1 | −7.58392986e−009 |
| C2 | 4.41224612e−013 |
| C3 | −1.06008880e−017 |
| C4 | 2.13499640e−022 |
| C5 | −6.70700084e−027 |
| C6 | 2.40325705e−031 |
| C7 | 0.00000000e+000 |
| C8 | 0.00000000e+000 |
| C9 | 0.00000000e+000 |

Surface No. 22

| | |
|---|---|
| K | 0.0000 |
| C1 | 2.87964134e−008 |
| C2 | 6.20983585e−013 |
| C3 | 2.89906100e−017 |
| C4 | 2.50860023e−021 |
| C5 | −1.13275024e−025 |
| C6 | 1.01001015e−029 |
| C7 | 0.00000000e+000 |
| C8 | 0.00000000e+000 |
| C9 | 0.00000000e+000 |

Surface No. 24

| | |
|---|---|
| K | 0.0000 |
| C1 | −4.75939212e−008 |
| C2 | −2.33700311e−012 |
| C3 | −1.88912932e−016 |
| C4 | −4.63774950e−020 |
| C5 | 5.74100037e−024 |
| C6 | −1.41608387e−027 |
| C7 | 0.00000000e+000 |
| C8 | 0.00000000e+000 |
| C9 | 0.00000000e−000 |

Surface No. 32

| | |
|---|---|
| K | 0.0000 |
| C1 | −4.75939212e−008 |
| C2 | −2.33700311e−012 |
| C3 | −1.88912932e−016 |
| C4 | −4.63774950e−020 |
| C5 | 5.74100037e−024 |
| C6 | −1.41608387e−027 |
| C7 | 0.00000000e+000 |
| C8 | 0.00000000e+000 |
| C9 | 0.00000000e+000 |

Surface No. 34

| | |
|---|---|
| K | 0.0000 |
| C1 | 2.87964134e−008 |
| C2 | 6.20983585e−013 |
| C3 | 2.89906100e−017 |
| C4 | 2.50850023e−021 |
| C5 | −1.13275024e−025 |
| C6 | 1.01001015e−029 |
| C7 | 0.00000000e+000 |
| C8 | 0.00000000e+000 |
| C9 | 0.00000000e+000 |

Surface No. 38

| | |
|---|---|
| K | 0.0000 |
| C1 | 5.63556514e−009 |
| C2 | 2.25868351e−013 |
| C3 | −1.29914815e−017 |
| C4 | 1.04287938e−022 |
| C5 | 1.71121371e−026 |
| C6 | −8.74238375e−031 |
| C7 | 0.00000000e+000 |
| C8 | 0.00000000e+000 |
| C9 | 0.00000000e+000 |

Surface No. 40

| | |
|---|---|
| K | 0.0000 |
| C1 | −4.07014923e−008 |
| C2 | −3.66567974e−012 |
| C3 | 1.83475111e−016 |
| C4 | −5.50386581e−021 |
| C5 | 9.03780648e−025 |
| C6 | −3.34645582e−029 |
| C7 | 0.00000000e+000 |
| C8 | 0.00000000e+000 |
| C9 | 0.00000000e+000 |

Surface No. 42

| | |
|---|---|
| K | 0.0000 |
| C1 | 2.56062787e−008 |
| C2 | 1.19461884e−012 |
| C3 | −4.54392317e−017 |
| C4 | 3.60207145e−021 |
| C5 | −1.28609637e−025 |
| C6 | 4.80120451e−030 |
| C7 | 0.00000000e+000 |
| C8 | 0.00000000e+000 |
| C9 | 0.00000000e+000 |

Surface No. 49

| | |
|---|---|
| K | 0.0000 |
| C1 | −3.90074679e−008 |
| C2 | 4.08096340e−015 |
| C3 | −4.52858217e−018 |
| C4 | 2.55659287e−023 |
| C5 | −1.83353366e−027 |
| C6 | −8.43484507e−032 |
| C7 | 0.00000000e+000 |
| C8 | 0.00000000e+000 |
| C9 | 0.00000000e+000 |

Surface No. 57

| | |
|---|---|
| K | 0.0000 |
| C1 | −1.59222176e−008 |
| C2 | −2.225S3295e−012 |
| C3 | 2.21753001e−016 |
| C4 | −2.35152442e−020 |
| C5 | 1.42194804e−024 |
| C6 | −4.58043034e−029 |
| C7 | 0.00000000e+000 |
| C8 | 0.00000000e+000 |
| C9 | 0.00000000e+000 |

1. A catadioptric projection objective for imaging a pattern arranged on the object plane of the projection objective, on the image plane of the projection objective, having:
a first objective part for imaging an object field in a first real intermediate image,
a second objective part for producing a second real intermediate image with the radiation coming from the first objective part; and
a third objective part for imaging the second real intermediate image on the image plane; wherein
at least one of the objective parts is a catadioptric objective part with a concave mirror, and
at least one of the objective parts is a refractive objective part and a folding mirror is arranged within this refractive objective part in such a way that a field lens is arranged between the folding mirror and an intermediate image which is closest to the folding mirror.

2. The projection objective as claimed in claim 1, wherein the field lens is a single lens.

3. The projection objective as claimed in claim 1, wherein the field lens is formed by a lens group having at least two single lenses.

4. The projection objective as claimed in claim 1, wherein the field lens has positive refractive power.

5. The projection objective as claimed in claim 1, wherein the field lens is arranged in the optical vicinity of a field plane in an area in which the principal beam height of the image is large in comparison to the marginal beam height.

6. The projection objective as claimed in claim 1, wherein the catadioptric objective part has a concave mirror with an associated folding mirror in order to deflect either the radiation coming from the object plane in the direction of the concave mirror or the radiation reflected by the concave mirror in the direction of the image plane of the projection objective, wherein:
the folding mirror is located within a refractive objective part which is closest to the catadioptric objective part;
an intermediate image exists in a beam path between the concave mirror and the folding mirror; and
the field lens is arranged between this intermediate image and the folding mirror.

7. The projection objective as claimed in claim 1, wherein the concave mirror has an associated folding mirror for deflecting the radiation coming from the object plane in the direction of the concave mirror, or for deflecting the radiation coming from the concave mirror in the direction of the image plane, and the field lens is arranged geometrically between the concave mirror and the folding mirror in an area through which the beam passes twice, such that a first lens area of the field lens is arranged in the beam path between the object plane and the concave mirror, and a second lens area of the field lens is arranged in the beam path between the concave mirror and the image plane.

8. The projection objective as claimed in claim 1, wherein the field lens is arranged such that it is arranged not only in the optical vicinity of a field plane which is located in the beam path upstream of the concave mirror, but also in the optical vicinity of a field plane which is located in the beam path downstream from the concave mirror.

9. The projection objective as claimed in claim 8, wherein the field plane which is located upstream of the concave mirror and the field plane which is located downstream from the concave mirror is an intermediate image plane.

10. The projection objective as claimed in claim 1, wherein the field lens is arranged in an area through which the beam passes twice, and has a first lens area, through which the beam passes in a first direction, as well as a second lens area through which the beam passes in a second direction, with the first lens area and the second lens area not overlapping one another on at least one side of the lens.

11. The projection objective as claimed in claim 1, wherein at least one multiple area lens which is used as a field lens is arranged in an area through which the beam passes twice, which multiple area lens has a first lens area through which the beam passes in a first direction and has a second lens area through which the beam passes in a second direction, with the first lens area and the second lens area not overlapping one another, at least on one side of the lens.

12. The projection objective as claimed in claim 1, wherein the field lens is arranged in an area through which the radiation passes only once.

13. The projection objective as claimed in claim 1, which has two, and only two, real intermediate images.

14. The projection objective as claimed in claim 1, having:
a first objective part for imaging an object field which is located on the object plane in a first real intermediate image,
a second objective part for producing a second real intermediate image with the radiation coming from the first objective part,
a third objective part for producing a third real intermediate image with the radiation coming from the second objective part, and
a fourth objective part for imaging the third real intermediate image on the image plane, wherein
at least one of the objective parts is a catadioptric objective part with a concave mirror, and
at least one of the objective parts is a refractive objective part and a folding mirror is arranged within this refractive objective part in such a way that a field lens is arranged between the folding mirror and an intermediate image which is closest to the folding mirror.

15. The projection objective as claimed in claim 14, which has three, and only three, real intermediate images.

16. The projection objective as claimed in claim 1, wherein at least one folding mirror is provided in the first objective part, which images the object plane in a first intermediate image, such that the optical axis within the objective part which is closest to the object is folded at least once.

17. The projection objective as claimed in claim 1, wherein at least one folding mirror is provided in a last objective part upstream of the image plane, which images a last intermediate image on the image plane, such that the optical axis within the objective part which is closest to the image is folded at least once.

18. The projection objective as claimed in claim 1, wherein two of the objective parts are catadioptric and each have one concave mirror.

19. The projection objective as claimed in claim 1, wherein the first objective part is refractive, and the second objective part and the third objective part are in the form of catadioptric objective parts each having one concave mirror, and each of the concave mirrors has an associated folding mirror either to deflect the radiation to the concave mirror or to deflect the radiation coming from the concave mirror in the direction of a downstream objective part.

20. The projection objective as claimed in claim 1, wherein all the intermediate images are arranged in the vicinity of a folding mirror.

21. The projection objective as claimed in claim 1, wherein all the intermediate images are arranged at a distance from a folding mirror.

22. The projection objective as claimed in claim 1, wherein only one catadioptric objective part is provided.

23. The projection objective as claimed in claim 1, having:
a first, refractive objective part for imaging the object field in a first real intermediate image,
a second catadioptric objective part for producing a second real intermediate image with the radiation coming from the first objective part, and
a third refractive objective part for imaging the second real intermediate image on the image plane, wherein a folding mirror is arranged within at least one of the refractive objective parts such that a field lens is arranged between the folding mirror and an intermediate image which is located closest to the folding mirror.

24. The projection objective as claimed in claim 23, wherein the catadioptric objective part has an optical axis which is aligned essentially parallel to an object-side section and an image-side section of the optical axis.

25. The projection objective as claimed in claim 1, wherein
the catadioptric objective part has a concave mirror which has an associated first folding mirror;
wherein a first beam section which runs from the object plane to the concave mirror and a second beam section which runs from the concave mirror to the image plane can be produced;
and the first folding mirror is arranged with respect to the concave mirror such that one of the beam sections is folded at the first folding mirror and the other beam section passes the first folding mirror without any vignetting, and the first beam section and the second beam section cross over in a crossing area.

26. The projection objective as claimed in claim 25, wherein the first folding mirror is arranged such that the first beam section is folded at the first folding mirror, and the second beam section passes the first folding mirror without any vignetting.

27. The projection objective as claimed in claim 25, wherein the first folding mirror is arranged such that the first beam section passes the first folding mirror without any vignetting, and the second beam section is folded at the first folding mirror.

28. The projection objective as claimed in claim 25 which, in addition to the first folding mirror, has at least one second folding mirror.

29. The projection objective as claimed in claim 25, wherein the at least one second folding mirror is aligned relative to the first folding mirror such that the object plane and the image plane run parallel to one another.

30. The projection objective as claimed in claim 1, which is designed for ultraviolet light from a wavelength band between about 120 nm and about 260 nm.

31. The projection objective as claimed in claim 1, which is designed as an immersion objective such that an immersion medium with a high refractive index is introduced, during operation, between an outlet surface of the projection objective and an input surface of the substrate.

32. The projection objective as claimed in claim 31, wherein the immersion medium has a refractive index of n_{I}≧1.3 at the operating wavelength.

33. The projection objective as claimed in claim 32, which has an image-side numerical aperture of NA>1 in conjunction with the immersion medium.

34. The projection objective as claimed in claim 33, wherein the numerical aperture is NA≧1, and/or NA≧1.1 and/or NA≧1.2 and/or NA≧1.3.

35. A projection exposure system for microlithography having an illumination system and a catadioptric projection objective for imaging of a pattern, which is arranged on an object plane of the projection objective, on an image plane of the projection objective, having:
a first objective part for imaging an object field in a first real intermediate image,
a second objective part for producing a second real intermediate image with the radiation coming from the first objective part;
and a third objective part for imaging the second real intermediate image on the image plane; wherein
at least one of the objective parts is a catadioptric objective part with a concave mirror, and
at least one of the objective parts is a refractive objective part and a folding mirror is arranged within this refractive objective part in such a way that a field lens is arranged between the folding mirror and an intermediate image which is closest to the folding mirror.

36. A method for production of semiconductor components and other finely structured components having the following steps:
providing a mask with a predetermined pattern in the area of an object plane of a catadioptric projection objective;
illuminating the mask with ultraviolet light at a predetermined wavelength;
projecting an image of the pattern onto a light-sensitive substrate, which is arranged in the area of the image plane of a projection objective, with the aid of a catadioptric projection objective as claimed in claim 1.
